(19) United States
(12) Patent Application Publication
(10) Pub. No.: US 2004/0078758 A1
(43) Pub. Date: Apr. 22, 2004

(54) Method for producing documented medical image information

(76) Inventor: Rainer Kuth, Herzogenaurach (DE)

Correspondence Address: SCHIFF HARDIN, LLP, PATENT DEPARTMENT, 6600 SEARS TOWER, CHICAGO, IL, 60606-6473, US

(21) Appl. No.: 10/467,732

(22) PCT Filed: Jan. 30, 2002
(86) PCT No.: PCT/DE02/00326

(30) Foreign Application Priority Data
Feb. 12, 2001 (DE) 101-06-394.6

(51) Int. Cl. G06F 19/00

(52) U.S. Cl. 715/513

(57) ABSTRACT

The invention relates to a method for producing documented medical image information which is stored on a machine-readable storage medium (10) for transmission from a first location to a second location. The method comprises the selection of medical image information, recording of a pronouncement with respect to the selected medical image information and the linkage of said image information to the pronouncement in such a way that the image information and the pronouncement can be jointly reproduced. The medical information and the pronouncement are stored on a machine-readable medium (10).

The invention is directed to a method for producing a documented medical image information and for storing the documented medical image information for transmission from a first to a second location.

The problem often arises in medical technology that great quantities of data of medical image information must be transmitted from one location to another location. For example, such a situation exists when a general practitioner refers a patient to a radiologist for a radiological examination. During the course of examining the patient, the radiologist produces medical image information of the patient that the radiologist sends to the referring general practitioner together with a physician's report for the general practitioner's further treatment of the patient. As a rule, the radiologist records the medical image information on X-ray films. However, X-ray films exhibit the disadvantage that they are comparatively expensive, with an average price of about DM 10 per sheet of film. Over and above this, the image information only exists in black-and-white and can at most be provided with static, graphic supplemental information, for example with arrows, for explaining the medical image information. The critical diagnostic information must therefore usually be set down in a separately produced physician's report.

DE 100 08 054 A1 in fact discloses to medical images be stored on a CD-ROM in order to be able to transfer these images from one location to another. However, the separate creation of a documentation of the images in the form of a physician's report is still always required. Over and above this, difficulties with respect to the image formats and their storing on a CD-ROM occur to the effect that the radiologist works with a software differing from that of the referring general practitioner, i.e. the referring general practitioner does not have suitable software available for the playback of the medical image information.

DE 44 15 818 C2 discloses an arrangement for the digital integration of examination systems into EDP systems. Using this arrangement, audio data and text data can be recorded for image information acquired with examination systems, said audio and text data being capable of being stored in common with the image information. As a result thereof, the image, audio and text data can be reproduced at a later point in time.

U.S. Pat. No. 6,140,936 A discloses an electronic storage medium for medical data on which text data, images as well as multimedia audio and video datafiles can be stored.

JP 04285540 A discloses a device with which analysis data of a medical image can be allocated to the image and can be displayed together with the image.

The present invention is based on the object of specifying a method of the species initially cited that enables the production of a clearly documented medical image information and creates the pre-condition for a simple and easy playback of the documented medical image information.

This object is inventively achieved by a method according to claim 1. For producing a documented medical image information and for storing the documented medical image information for the transmission from a first to a second location, it is inventively provided that, for example, a physician producing the medical image information be given the possibility of selecting a medical image information insofar as necessary and of providing the medical image information with an explanation, whereby the medical image information and the explanation are linked to one another such that they can be reproduced in common, preferably simultaneously. The explanation comprises advantageously least one graphic character that can be inserted into the medical image information, whereby said graphic character can, for example, be a matter of an arrow. By prescribing and storing parameters for the graphic playback of the graphic character, the graphic character can thereby be moved relative to the medical image information in the playback of the medical image information. Accordingly, explanations related to a medical image information can be more clearly and pithily undertaken.

It is also provided that the medical image information and the explanation be stored on a machine-readable storage medium that can be transported from a first to a second location in a simple way. The advantage of the present invention is thus comprised in not only being able to store a medical image information on a machine-readable storage medium but of also being able to provide or, respectively, link this with at least an adequate explanation that can be reproduced in common in an easy way due to the linking. Accordingly, the pre-conditions for a simple and easy playback of a documented medical image information are created since, due to the linking, for example, only the playback of the image information need be started in order to also start the explanation belonging thereto. The linking preferably ensues by means of what are referred to as logical pointers, i.e. a logical pointer allocated to the image information points to the explanation, so that the explanation is also reproduced given the playback of the image information. The separate preparation of a physician's report can be foregone in this way.

Embodiments of the invention provide that at least one computer program suitable for the playback of the medical image information and/or the explanation can be indicated or, respectively, selected in the production of the documented medical image information, whereby the selected computer program is also deposited on the machine-readable storage medium. By specifying and, in particular, by offering at least one suitable computer program for the playback of the medical image information and/or the explanation on the machine-readable storage medium, no software problems arise with respect to the playback for, for example, a referring physician. A first computer program for the playback of the image information and a second computer program for the playback of the explanation may potentially be needed. In this case, too, the logical pointer that, for example, is allocated to the image information and produces the linking points to the explanation, whereby the computer program for the playback of the explanation is also started with the start of the explanation [sic]. The image information and the explanation usually exist as a datafile.

Versions of the invention provide that the explanation comprises written words and/or spoken words, whereby the spoken words are recorded as an audio datafile capable of being played back. Written words can be directly input, for example via a keyboard connected to a computer and be allocated or attached to the appertaining image information or, respectively, to the image datafile containing the image information. However, there is also the possibility of converting spoken words recorded with a microphone into written words with the assistance of an inherently known speech recognition system, said written words being attached to the appertaining medical image information or, respectively, to the image datafile containing the image information or being allocated thereto with logical pointers. The employment of a microphone also lies at hand for recording explanations comprising spoken words on an audio datafile. Upon playback of the medical image information, these words stored in the audio datafile can be played back with a loudspeaker, for example for a referring general practitioner.

Embodiments of the invention provide that the explanation comprises a dynamic variation of the presentation of at least a part of the medical image information for the graphic playback of the medical image information, and that parameters for the dynamic variation can be prescribed. For example, such parameters comprise the temporal modification of color gradations of an image information presented in what is referred to as a window on an image playback device as well as values relating to the size of the window and/or what are referred to as zoom values. Recorded medical image information can also be pithily and clearly presented in this way in order to particularly point out special features contained in the medical image information.

Other embodiments of the invention provide that the explanation comprises a series of medical image information and that parameters can be prescribed for the graphic playback of the series of medical image information. When, thus, it is not only a single medical image information but an entire series of medical image information that have been recorded, what is referred to as a cinema playback of the medical information can ensue by prescribing such a parameter set, said cinema playback being understood to be the successive playback of various medical information at short time intervals, so that the impression that a film is running arises. The parameters of such a parameter set comprise, for example, the plurality and sequence of the image information to be played back as well as the time lying between the playback of two successive image information.

According to a further version of the invention, operating elements are provided for the selection of the medical image information to be stored and, potentially, for the selection of the computer program, said operating elements comprising at least the operating functions of “start”, “stop” and “end”. Over and above this, it is provided according to a further version of the invention that the computer program for the graphic playback of the medical image information and/or of the explanation comprises operating elements for the playback that comprise at least the operating functions “start”, “stop”, “forward”, “back” and “abort”. For example, such operating elements can be realized on a graphic user interface of a computer program in the form of what are referred to as “buttons”, which are understood to be, for example, switches that can be activated or deactivated with the assistance of a pointer of a computer mouse.

An exemplary embodiment of the invention is shown in the attached, schematic drawings. Shown are:

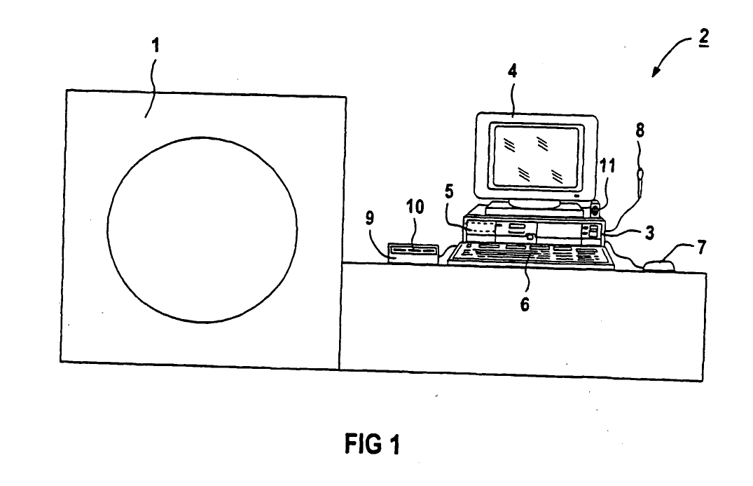

FIG. 1 a medical apparatus having a device for producing a documented image information;

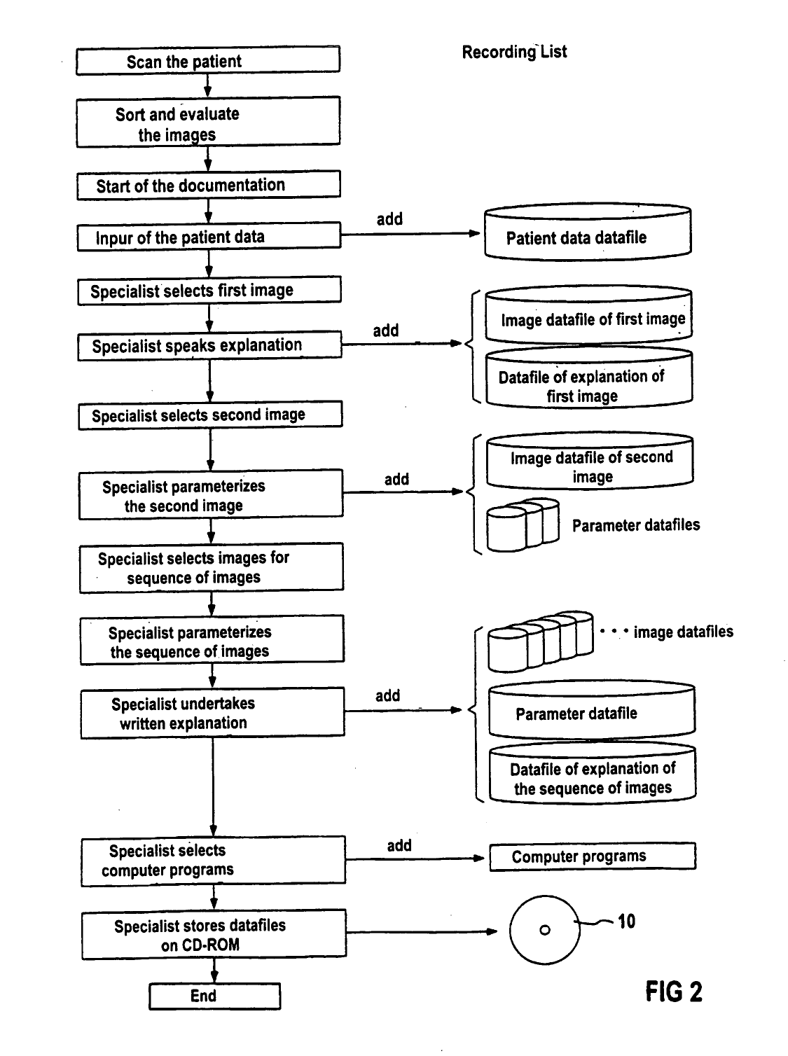

FIG. 2 a flowchart illustrating an execution of the production of a documented medical image information;

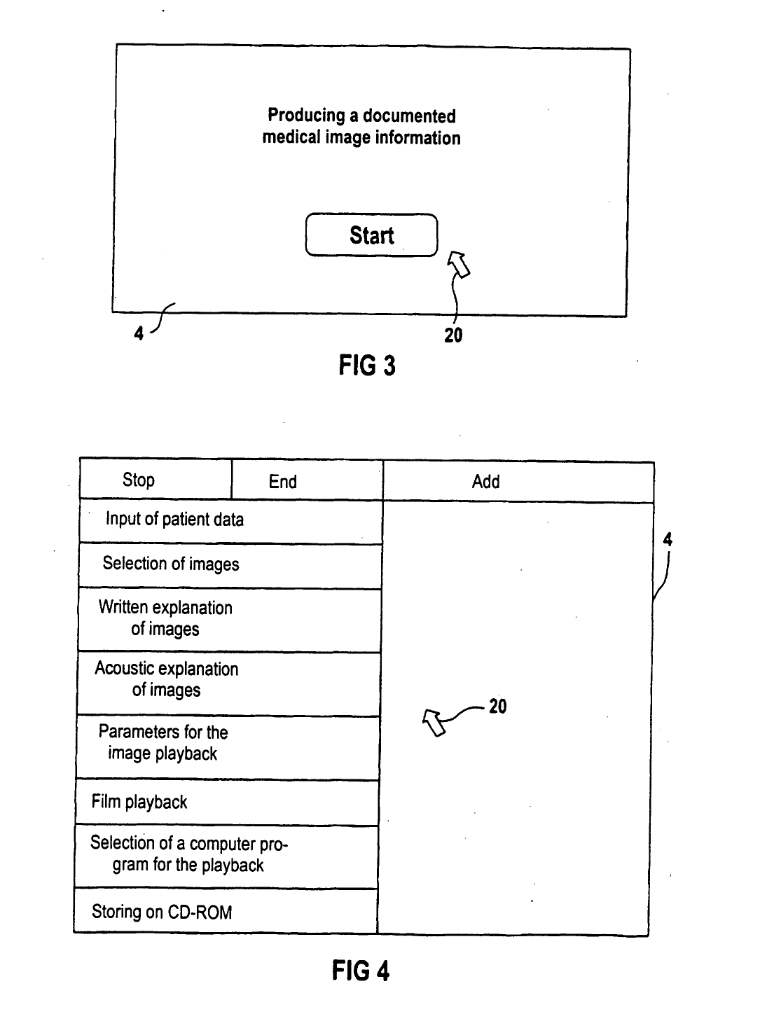

FIGS. 3,4 schematic illustrations of two picture screen masks of a program for producing a documented medical image information; and

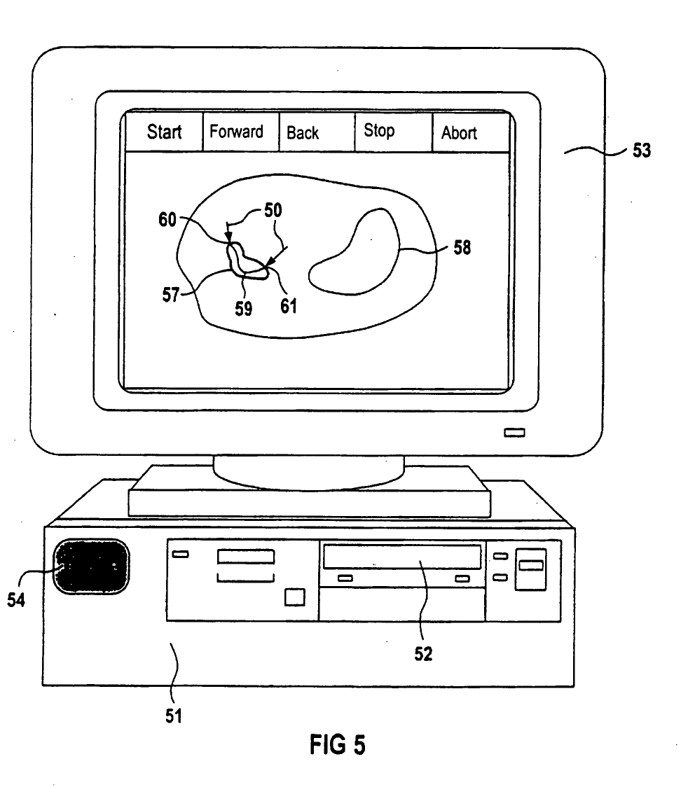

FIG. 5 a playback device for the documented image information.

In the case of the present exemplary embodiment, the medical apparatus shown in FIG. 1 is a magnetic resonance apparatus 1 that comprises a device 2 for producing a documented image information. In the present exemplary embodiment, said device 2 comprises a computer 3 having a display device 4, a data store in the form of a hard disk 5, input means connected to interfaces of the computer 3 and having the of a keyboard 6 and a computer mouse 7, having a microphone 8 connected to an interface of the computer 3 and having a loudspeaker connected to an interface of the computer 3. The device 2 also comprises a device 9 for writing a CD-ROM 10 with data that is connected to an interface of the computer 3. Said interfaces of the computer 3 are a matter of known interfaces that are therefore not described in greater detail here.

In the present exemplary embodiment, the magnetic resonance apparatus 1 and the device 2 are a component part of a specialist's practice and are provided for acquiring medical images of patients, for documenting these and storing them on a CD-ROM in order to have these forwarded to physicians for the further treatment of patients who referred patients to the specialist. FIG. 2 shows an exemplary form of an executive sequence for producing a documents image information according to the inventive method in the form of a flowchart.

For producing a documented medical image information, first, a specialist (not shown) generates medical image information in the form of magnetic resonance images of a patient (likewise not shown in FIG. 1) in what is referred to as a scan with the magnetic resonance apparatus 1. After being generated, the images are stored on the hard disk 5 of the computer 3 and can be viewed by the specialist, modified and evaluated by means of a suitable, inherently known image processing software. At this stage, the specialist decides which of the images he/she would like to use for a diagnosis, document and store on a CD-ROM for forwarding to another physician.

For documentation of the images, the specialist starts a computer program for producing a documented medical image information that, for example, comprises the start page shown in FIG. 3 with a “start” button. After pressing the “start” button in that the specialist moves the pointer 20 indicated in FIG. 3 and allocated to the computer mouse 7 to the “start” button with the computer mouse 7 and activates it with the computer mouse 7, the specialist arrives at a second page that is schematically shown in FIG. 4 and has the operating elements or, respectively, menu points “stop”, “end”, “add”, “input patient data”, “select images”, “written explanation of images”, “acoustic explanation of images”, “parameters for the image playback”, “film playback”, “selection of a computer program for the image playback” and “store on CD-ROM”.

At the beginning of the recording, the specialist selects the menu point “input patient data” with the computer mouse 7, whereby the specialist proceeds to a window (not explicitly shown) in which he/she can enter the personal data of the examined patient via the keyboard 6 of the computer 3 as well as further data pertaining to the examination that are stored in a recording datafile allocated to the patient of added to a recording list stored in a datafile. In both of the possible versions, the specialist ends the input by actuating the button “add”.

It is assumed below that the information are deposited in datafile form in a recording list.

By actuating the button “select images”, the specialist can select the first image intended for the recording list from a listing in which the previously acquired images were stored. In the present exemplary embodiment, the specialist would like to record a spoken explanation for the first image. By activating the button “acoustic explanation of images” with the computer mouse 7, he/she proceeds into the recording mode for spoken words for this purpose and, with the assistance of the microphone 8 connected to the computer 3, records his/her comments about the first image in an audio datafile that is allocated to the first image. The recording mode offers the specialist corresponding operating functions in order to start the acoustic recording of the words, pause, carry out corrections and end it. After the end of the explanation, the first image (which exists as image datafile) and the audio datafile belonging thereto are added to the recording list by activating the button “add”. During the course of this operation, the computer 3 uses a logical pointer to link the audio datafile to the image datafile of the first image in that the pointer allocated to the image datafile points to the audio datafile, so that the explanation belonging to the first image is automatically played back upon playback of said first image. The linking of the datafiles thereby ensues in a known way that cannot be registered by the specialist.

In a way corresponding to that for the first image, the specialist subsequently selects a second image from the listing of generated images in the present exemplary embodiment. The specialist would like to supplement this second image with an arrow 50 that should glide over a first image content of the second image during the playback of said second image. During the playback of the second image, moreover, the specialist would like to have the first image content of the second image change color and that a second image content be zoomed. The specialist activates the button “parameters for the image playback” for this purpose, whereupon he/she proceeds into an input mask (likewise not shown) in which an arrow 50 can be selected and the orientation of the arrow 50, the initial position of the arrow 50, the final position of the arrow 50 and the course of the curve of the arrow 50 from the initial position into the final position of the arrow 50 across the second image as well as the time duration during which the arrow 50 should proceed from the initial position into the final position along the course of the curve can be input. Moreover, the first image content that should change in color and the second image content to is to be zoomed can be selected. He/she can thereby input the way in which and over which time the first image content should change color or, respectively, to what extent and in what time the second image content should be zoomed. Before the specialist defines the parameters for the graphic playback of the arrow 50 and the parameters for the dynamic variation of the presentation of the second image in the playback of the second image, he/she can check the effects of the three parameter sets in a test run. Subsequently, the second image, the parameter set for the arrow motion, the parameter set for the color change of the first image content as well as the parameter set for the zooming of the second image content are respectively added to the recording list in datafile form by actuating the button “add”, whereby a linking of the image datafile of the second image to the three parameter datafiles by means of logical pointers is likewise carried out by the computer 3.

In addition to the first and second image, the specialist in the present exemplary embodiment selects a plurality of previously generated images from the listing in which the images are stored. The specialist would like to store the images such that they can be played back like a film, i.e. that the images are successively displayed at short time intervals in the playback. To this end, the specialist activates the button “film playback”, whereby he/she proceeds into an input mask (not shown) in which he/she can input the plurality of images to be played back, the sequence of the images as well as the time intervals wherein the images should be displayed in the playback. Before the specialist fixes there parameters, he/she can carry out a test run of the cinema playback. When he/she finds the sequence of the images to be suitable, he/she fixes the parameters. Additionally, the specialist would like to provide a written explanation relating to the cinema mode. To this end, he/she actuates the button “written explanation of images”, whereupon he/she proceeds into an input mask (not shown) wherein corresponding explanations of the individual images, the sequence of images as well as about the cinema playback can be input, for example via the keyboard 6 of the computer 3. As already described earlier, the specialist subsequently adds the individual images of the sequence of images, the parameter set for the film playback of the images as well as the written explanation of the images to the recording list in datafile form by activating the button “add”. The linking of the datafiles is again carried out by the computer 3 with logical pointers.

In a further step, the specialist activates the button “select a program for the image playback” in the present exemplary embodiment, whereupon he/she proceeds into an input mask (not shown) wherein a plurality of suitable computer programs are offered for the playback of the images as well of his/her explanations that were provided in written form, in acoustic form or in graphic form and were added to the recording list in datafile form. The specialist selects the computer programs required for the playback therefrom and adds these to the recording list by activating the button “add”. At this stage, all of the information that are to be stored on a machine-readable storage medium are present. Accordingly, the specialist need now only insert a suitable machine-readable storage medium—a multimedia CD-ROM 10 in the present exemplary embodiment—into the device 9 for writing a CD-ROM and, by activating the button “store on CD-ROM”, activate an appropriate, known program for writing the CD-ROM 10, so that the image datafiles present in the recording list, datafiles with explanations and parameter datafiles together with the selected computer programs for the playback of the images and explanations contained in the various datafiles are digitally stored on the CD-ROM 10 by what is referred to as burning the CD-ROM 10. After the storing, finally, the recording procedure is ended by actuating the button “end”.

Finally, the CD-ROM can be communicated in a simple way to another physician who needs image information for a further treatment of the patient. All the physician needs for the playback of the information stored on the CD-ROM 10 is a computer 51 with corresponding performance capability that must comprise—among other things—a CD-ROM drive 52, a display device 53 and a loudspeaker 54, as shown in FIG. 5. Since it is not only the image datafiles, the datafiles with explanations and the parameter datafiles but also the corresponding computer programs for the playback of the information stored in these datafiles that are present on the CD-ROM 10, the physician does not need any specific programs in order to play back the information. The physician merely has to activate the computer programs for the playback of the information. In the present exemplary embodiment, the physician activates a first computer program, whereupon he/she proceeds into a start page on which operating elements like “start”, “stop”, “forward”, “back” and “abort” are displayed. When the physician activates the “start” button, the playback of the recorded information is started upon activation of the computer programs that have been co-supplied for the playback, and the first image is displayed (in a way that is not shown) upon playback of the explanations stored in the audio datafile. When the physician activates the “forward” button, then he/she proceeds to the second image, an arrow 50 gliding across image information of the second image, a first image content changing color and a second image content being zoomed when this is displayed, as previously stored. This situation is schematically illustrated for the second image in FIG. 5 that shows a picture of two kidneys 57, 58 of a patient. How the arrow 50 moves along the curve 59 from its initial position 60 into its final position 61 is indicated. As the first image content, the kidney 57 thereby changes color in a way that cannot be shown. As the second image content 58, the kidney 58 has been zoomed and, accordingly, is displayed in a magnified presentation.

By means of a further activation of the “forward” button, finally, the sequence of images can be played back as film, whereby the corresponding explanation is thereby displayed.

During the playback, the physician has the possibility of stopping the playback with the “stop” button, of rocking back and forth from one image to another by activating the buttons “forward” or “back” or of ending the image playback by activating the “abort” button.

The above-described executive sequence of the method form producing a documented medical image information, moreover, is only to be understood as being by way of example. Accordingly, the executive sequence can also be different. The specialist is thus free regarding which images he/she would like to add to the recording list and how he/she would like to provide the comments to the images, which are understood to include written explanations, acoustic explanations recorded in an audio datafile, explanations in the form of graphic characters, explanations in the form of a dynamic modification of the presentation of the medical image information or explanations in the form of image sequences that can be arbitrarily combined with one another. Menu points other than those made available in FIG. 4 for the compilation of the recording list can also be made available to the specialist for this purpose.

Further, the entire recording list need not be produced first, with the datafiles being stored on the machine-readable storage medium only thereafter. On the contrary, a plurality of datafiles that may potentially be linked to one another can also be produced and stored little by little on the machine-readable storage medium dependent on their production. Over and above this and as already indicated, there is also the possibility of generating only a single recording datafile that contains image data and explanations and of storing this on the machine-readable storage medium.

It is also not absolutely necessary to select a computer program for the playback of the image information and/or the explanations and store it on the machine-readable storage medium. On the contrary, this can be entirely foregone when a declaration is made to employ a standard program, or the computer program with which the playback can be accomplished can simply be indicated.

The machine-readable storage medium need not necessarily be a CD-ROM or a multimedia CD-ROM. On the contrary, other machine-readable storage media that, in particular, are easy to transport are also suited for storing the recording datafile, for example an MOD (magneto-optical disk) or magnetic stores in general.

The medical apparatus also need not necessarily be a magnetic resonance apparatus. On the contrary, the medical apparatus can also be an X-ray computer tomograph, an X-ray device, an ultrasound device or some other imaging modality.

1. Method for producing a documented medical information and for storing the documented medical information for the transmission from a first to a second location, comprising the following method steps:
selecting the medical information;
recording an explanation of the selected medical image information;
linking the medical image information to the explanation such that the medical image information and the explanation can be played back in common; and
storing the medical image information and the explanation of the medical image information on a machine-readable storage medium, whereby
the explanation comprises a graphic character (5) insertable into the medical image information, and whereby parameters for a movement of the graphic character (50) relative to the medical image information in the playback of the medical information can be prescribed and stored.

2. Method according to claim 1, whereby at least one computer program suitable for the playback of the medical image information and/or the explanation can be indicated.

3. Method according to claim 1, whereby at least one computer program suitable for the playback of the medical information and/or the explanation can be selected and stored on the machine-readable storage medium together with the medical image information and the explanation of the medical image information.

4. Method according to one of the claims 1 through 3, whereby the explanation comprises written words.

5. Method according to one of the claims 1 through 4, whereby the explanation comprises spoken words that are recorded as an audio datafile capable of being played back.

6. Method according to one of the claims 1 through 5, whereby the explanation comprises a dynamic modification of the presentation of at least a part (57, 58) of the medical image information.

7. Method according to claim 6, whereby parameters for a dynamic modification of the presentation of at least a part (57, 58) of the medical image information can be prescribed for the graphic playback of the medical image information.

8. Method according to one of the claims 1 through 7, whereby the explanation comprises a sequence of medical image information.

9. Method according to claim 8, whereby parameters for the graphic playback of the sequence of medical image information can be prescribed.

10. Method according to one of the claims 1 through 9, whereby operating elements for the selection of the medical image information to be stored, for the recording of the explanation of the medical image information and, potentially, for the selection of the computer program are provided that comprise at least the operating functions “star”, “stop” and “end”.

11. Method according to one of the claims 2 through 10, whereby the computer program for the graphic playback of the medical image information and/or of the explanation comprises operating elements that comprise at least the operating functions “start”, “stop”, “forward”, “back” and “abort”.

12. Method according to one of the claims 1 through 11, whereby the machine-readable storage medium is a CD-ROM (10).
